(19) United States
(12) Patent Application Publication
(10) Pub. No.: US 2005/0200884 A1
(43) Pub. Date: Sep. 15, 2005

(54) Image forming apparatus

(75) Inventors: Shinji Arase, Tamana-shi (JP); Masanobu Katsumura, Kumamoto-shi (JP); Takayuki Shiomi, Kumamoto-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/065,288

(22) Filed: Feb. 25, 2005

(30) Foreign Application Priority Data
Feb. 26, 2004 (JP) P. 2004-051101

(51) Int. Cl. G06F 15/00

(52) U.S. Cl. 358/1.15

(57) ABSTRACT

An image forming apparatus according to the invention comprises an image recording medium supplying unit in which an information recording medium including a radio communication medium is provided, a transport path in which the information recording medium supplied from the information recording medium supplying unit is transported, a transport unit for transporting the recording medium, an image erasing unit for erasing an image formed in the information recording medium, and an image forming unit for forming an image in the information recording medium. The apparatus has a configuration in which at least an antenna section of a radio communication medium processing unit communicating with the radio communication medium of the information recording medium is provided in the information recording medium supplying unit.

### BACKGROUND OF THE INVENTION

The present invention relates to an image forming apparatus for forming an image to an information recording medium including a radio communication medium such as an RF ID tag and erasing an image from the recording medium.

For example, RF ID systems utilizing RF ID tags have been put in practical use in physical distribution systems, air cargo managing systems, automatic ticket checking systems, room entrance/exit managing systems, traffic systems, and so on utilizing frequency bands such as the 13.56 MHz band.

Such an RF ID system includes RF ID tags having an IC chip and an antenna coil and a read-write device which communicates with the RF ID tags, and the read-write device is equipped with a loop antenna. Power and transmission data are always or intermittently transmitted to acquire reception data from an RF ID tag located in a range in which the power and transmission data can be received.

The RF ID tags are available in various forms and are attached to or included in various types of information recording media to work with a wide variety of RF ID systems.

Referring now to an example of a system utilizing an RF ID system and information recording media used in such a system, when an RF ID system is used in a physical distribution system or air cargo managing system, the information recording media will be management slips, delivery slips, and package labels having RF ID tags. Further, when used in an automatic ticket checking system, the information recording media will be tickets and passes having RF ID tags. In a room entrance/exit management system, ID cards will be the media. A system involving personal authentication with passes or ID cards is sometimes referred to as a non-contact IC card system.

In some of those RF ID systems, an image of information recorded in an IC chip in an RF ID tag is formed as visible information on a surface of the information recording medium in which the RF ID tag is provided.

Referring to methods for forming an image on an information recording medium, write-once type image forming methods are also available in that information is printed on a surface of the information recording medium by various printing units such as inkjet printers, heat-sensitive transfer printers, an laser beam printers, and a thermal printing in which a heat-sensitive color development layer is formed in advance on a surface of an information recording medium to allow heat-sensitive recording to be performed on the same.

Since the write-once type image forming methods do not allow a great amount of information to be displayed because of limitations on a printing area on a surface of an information recording medium, rewritable methods of image formation may be adopted. For example, a liquid crystal display element may be formed in an information recording medium, or display may be provided using a heat reversible material which can be repeatedly printed and erased by applying heat to the same.

In this connection, JP-A-2001-240218 discloses an air cargo managing system in which air cargos are automatically sorted, shipped, and received using IC baggage tags (information recoding media) having a writable display section formed by a non-contact IC tag (RF ID tag) and a heat reversible material. Further, JP-A-2001-243502 discloses an air ticket issuing system utilizing air tickets (information recording media) having a non-contact IC tag (RF ID tag) and a rewritable display section.

According to those techniques in the related art, an RF ID tag is attached to an information recording medium of an IC baggage tag or air ticket; a display section formed using a heat reversible material is provided on a surface of the information recording medium; communication is conducted between a reader/writer and the RF ID tag of the information recording medium to record desired information; and the display section of the information recording medium is rewritten (images are formed and erased) by a printer.

However, those techniques in the related art have a problem in that they result in low processing efficiency because processes on an RF IID tag of an information recording medium and processes on a display section of the information recording medium are performed by separate apparatus. When standby times spent by those apparatus during each other's processes are taken into account, processing time consequently increases creating the problem of further reduction of processing efficiency. Further more, since a configuration is employed in which a plurality of apparatus are connected with each other, the apparatus become large-sized as a whole, which has necessitated a large space for installation of the same.

### SUMMARY OF THE INVENTION

The invention solves those problems, and it is an object of the invention to provide an image forming apparatus for forming an image in an information recording medium including a radio communication medium such as an RF ID tag and erasing information therein, the apparatus having a large processing capacity and a small size.

An image forming apparatus according to the invention comprises an image recording medium supplying unit in which an information recording medium including a radio communication medium is provided, a transport path in which the information recording medium supplied from the information recording medium supplying unit is transported, a transport unit for transporting the recording medium, an image erasing unit for erasing an image formed in the information recording medium, and an image forming unit for forming an image in the information recording medium. The apparatus has a configuration in which at least an antenna section of a radio communication medium processing unit communicating with the radio communication medium of the information recording medium is provided in the information recording medium supplying unit.

The invention makes it possible to continuously and quickly perform processes on an information recording medium including a radio communication medium such as an RF ID tag, i.e., processes on the radio communication medium, erasure of an image in the information recording medium, and formation of an image in the information recording medium.

It is therefore possible to achieve an improvement in processing capacity and a size reduction in an image forming apparatus for forming an image in an information recording medium including a radio communication medium such as an RF ID tag and erasing an image in the same.

### BRIEF DESCRIPTION OF THE DRAWINGS

FIG. 1 is an external perspective view of an image forming apparatus according to Embodiment 1 of the invention;

FIG. 2 is a side sectional view of the image forming apparatus according to Embodiment 1 of the invention;

FIG. 3 is a plan view of an information recording medium according to Embodiment 1 of the invention;

FIG. 4 is a perspective plan view of a radio communication medium according to Embodiment 1 of the invention;

FIG. 5 is side sectional view of the image forming apparatus according to Embodiment 1 of the invention;

FIG. 6 is side sectional view of the image forming apparatus according to Embodiment 1 of the invention;

FIG. 7 is side sectional view of the image forming apparatus according to Embodiment 1 of the invention;

FIG. 8 is side sectional view of the image forming apparatus according to Embodiment 1 of the invention;

FIGS. 9A to 9E are plan views of examples of information recording media according to Embodiment 1 of the invention;

FIG. 10 is a perspective view of an example of a loop antenna according to Embodiment 1 of the invention.

### DETAILED DESCRIPTION OF THE PREFERRED EMBODIMENTS

Embodiments of the invention will now be described in detail with reference to the drawings.

### Embodiment 1

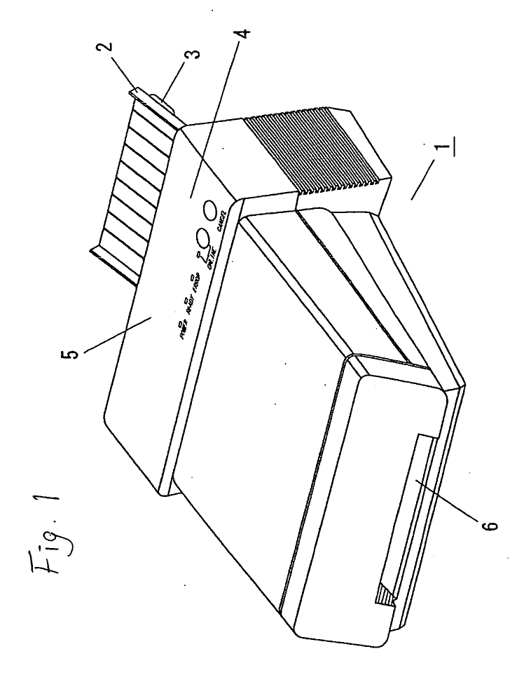

FIG. 1 is an external perspective view of an image forming apparatus according to Embodiment 1 of the invention. In FIG. 1, reference numeral 1 represents the image forming apparatus; reference numeral 2 represents a tray; reference numeral 3 represents an antenna section; reference numeral 4 represents an operation unit; reference numeral 5 represents a display unit; and reference numeral 6 represents a discharge opening.

As shown in FIG. 1, the image forming apparatus 1 has the tray 2, on which an information recording medium is placed, on the back side of thereof and the discharge opening 6, from which the information recording medium is discharged after an image is formed thereon, on the front side thereof opposite to the back side. The antenna section 3 is provided at the tray 2, and the antenna section 3 communicates with an RF ID tag as a radio communication medium included in the image information recording medium. Further, on the top of the housing of the image forming apparatus 1, there is provided the operation unit 4 which is constituted by keys and buttons and which enables, for example, on-line switching to an externally connected apparatus and cancellation of a process and the display unit 5 which is constituted by LEDs and which displays on and off states of the power supply and various statuses. While a radio communication medium in the context of the invention may be also referred to as, for example, a non-contact IC tag, a non-contact ID tag, or a radio tag instead of “RF ID tag”, what is meant by those terms is a medium capable of radio (non-contact) communication with a processing apparatus including the antenna section 3.

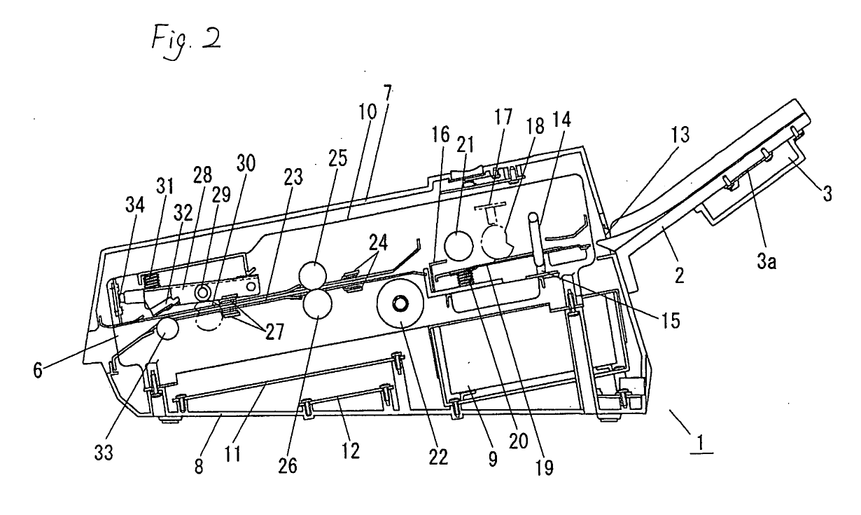

An internal configuration of the image forming apparatus 1 will now be described in detail with reference to FIG. 2. FIG. 2 is a side sectional view of the image forming apparatus of Embodiment 1 of the invention. FIG. 2 shows a state of the image forming apparatus 1 in which no information recording medium is set therein.

In FIG. 2, a tray 2 and an antenna section 3 are identical to those in FIG. 1, and reference numeral 3a represents a loop antenna. Further, reference numeral 7 represents a top housing, and reference numeral 8 represents a bottom housing. Reference numeral 9 represents a power supply. Reference numeral 10 represents a chassis. Reference numeral 11 represents a control substrate. Reference numeral 12 represents an RF ID tag control substrate. As shown in FIG. 2, the image forming apparatus is configured to contain the power supply 9, the chassis 10 which has mechanisms for performing processes such as transportation of an information recording medium and image formation, the control substrate 11, and the RF ID tag control board 12 in the housing of the same constituted by the top housing 7 and the bottom housing 8. The chassis 10 is secured to the bottom housing, and the power supply 9, the control substrate 11, and the RF ID tag control substrate 12 are disposed in the space between the chassis 10 and the bottom housing 8 and are secured to the bottom housing 8.

Referring first to a radio communication medium processing unit, the radio communication medium processing unit is constituted by the antenna section 3 and a reader/writer unit connected to the same. The loop antenna 3a for communicating with an RF ID tag is provided at the antenna section 3. The loop antenna 3a supplies power and transmission data to the RF ID tag and acquires reception data in the form of load fluctuations from the RF ID tag. FIG. 10 shows an example of the appearance of the same. As shown in FIG. 10, the loop antenna 3a is configured by forming a loop antenna pattern 3a2 on an antenna substrate 3a1. It is preferable to provide a magnetic member 3b on a back surface of the loop antenna 3a as shown in FIG. 10 because it will improve communication characteristics.

Although not shown in detail, the RF ID tag control substrate 12 serving as a reader/writer unit includes a radio transmission section for supplying power and transmission data to the loop antenna 3a, a radio reception section for acquiring reception data from the loop antenna 3a, and a control section for controlling the radio transmission section and the radio reception section. A resonance matching circuit section is provided in proximity to the neighborhood of a feeding point of the loop antenna 3a, and the output of the resonance matching circuit section is connected to the radio transmission section and the radio reception section of the RF ID tag control substrate 12 through a coaxial cable. Thus, the antenna section 3 having the loop antenna 3a is provided at the tray 2, and the RF ID tag control substrate serving as a reader/writer unit is provided separately from the same. As a result, the tray 2 can be made compact and, in addition, the RF ID tag control substrate 12 can be stably disposed in the housing. Alternatively, a radio communication medium processing unit formed by providing a reader/writer unit integrally with the antenna section 3 may be provided at the tray 2.

An information recording medium supplying unit will now be described. The information recording medium supplying unit is formed by the tray 2 and an information recording medium feeding mechanism.

Reference numerals 13, 14, 15, and 16 represent an insertion opening, a medium detection member, a sensor, and an engaging section, respectively. When an information recording medium is set in the image forming apparatus 1, the image recording medium is inserted in the image forming apparatus 1 through the insertion opening 13 and placed on the tray 2. At this time, the medium detection member 14 is urged by the information recording medium inserted and is thereby rotated about a shaft, and the sensor 15 detects that an image recording medium has been inserted from the rotation of the medium detection member 14. The engaging section 16 receives the information recording medium. The leading end of the information recording medium abuts on the engaging section 16 to be positioned thereby, and the information recording medium is thus disposed such that it extends between the engaging section 16 in the image forming apparatus 1 and the tray 2. The engaging section 16 engages both edges of the information recording medium in the width direction thereof.

The information recording medium feeding mechanism will now be described. Reference numeral 17 represents a sensor. Reference numeral 18 represents a cam. Reference numeral 19 represents a medium-urging metal fitting. Reference numeral 20 represents an elastic member constituted by a spring. Reference numeral 21 represents a medium separating roller. Reference numeral 22 represents a drive motor. The sensor 17 detects a movement of the cam 18. The cam 18 is in contact with the medium-urging metal fitting 19, and a rotation of the cam 18 causes upward and downward movements of the medium-urging metal fitting 19 which is urged upward by the elastic member 20. The upward and downward movements of the medium-urging metal fitting 19 caused by a rotation of the cam 18 results in upward and downward movements of the information recording medium provided. The medium separating roller 21 is driven for rotation by the drive motor 22. The medium separating roller 21 contacts the information recording medium and feeds the information recording medium into the apparatus (toward the discharge opening 6) utilizing friction with the medium. The contact between the information recording medium and the medium separating roller 21 is controlled by the upward and downward movements of the medium-urging metal fitting 19. A transport force of the medium separating roller 21 disengages the information recording medium from the engaging section 16 at the both edges of the leading end in the width direction thereof, and the medium becomes movable and is transported into the apparatus. When a plurality of information recording media is provided, the information recording medium located on top is fed in.

As thus described the information recording medium supplying unit is constituted by the tray 2 and the information recording medium feeding mechanism. Alternatively, the tray 2 and the information recording medium feeding mechanism may be partially integrated to be configured like a cassette which contains an information recording medium and which can be mounted and removed in and from the information recording apparatus 11. In this case, at least the antenna section 3 of the radio communication medium processing unit is provided at the cassette containing an information recording medium.

A transport path for an information recording medium will now be described. Reference numeral 23 represents a medium transport path, and reference numeral 24 represents a sensor. An information recording medium is fed into the medium transport path 23 by the medium separating roller 21, and the leading end of the medium is detected by the sensor 24. When the leading end of the information recording medium is detected by the sensor 24, the antenna section 3 communicates with he RF ID tag provided at the information recording medium to enable processes on the RF ID tag.

An image erasing unit will now be described. In FIG. 2, reference numeral 25 represents an erasing heater, and reference numeral 26 represents a platen roller. The erasing heater 25 serving as the image erasing unit is in the form of a roller incorporating a heater. The heater sandwiches an information recording medium in cooperation with the platen roller 26 in a face-to-face relationship therewith and erases an image recorded on the information recording medium. As will be detailed later, a display section formed of a heat reversible material is provided on a surface of the information recording medium, and an image recorded in the display section is erased by heat from the erasing heater 25. The erasing heater 25 always protrudes into the medium transport path 23.

An image forming unit will now be described. Reference numerals 27, 28, 29, 30, 31, 32, 33, and 34 represent a sensor, a printing unit, a cam follower, a cam, an elastic member constituted by a spring, a printing head, a platen roller, and a sensor, respectively. The sensor 27 detects the leading end of an information recording medium which is transported in the medium transport path 23 after being subjected to image erasure by the erasing heater 25. The printing unit 28 includes the cam follower 29 and the printing head 32. The cam 30 is in contact with the cam follower 29, and a rotation of the cam 30 causes upward and downward movements of the printing unit 28 which is urged downward by the elastic member 31. As a result, the printing unit 28 can enter and exit the medium transport path 23. The sensor 34 detects states of elevation as a result of the upward and downward movements of the printing unit 28/The printing head 32 of the printing unit 28 serving as an image forming unit sandwiches the information recording medium in cooperation with the platen roller 33 in a face-to-face relationship therewith and forms an image on the information recording medium. A so-called thermal head constituted by a group of heating resistor elements each forming one pixel is used as the printing head.

In FIG. 2, a discharge opening 6 is identical to that in FIG. 1, and the information recording medium is discharged from the discharge opening 6.

In the image forming apparatus 1 in Embodiment 1 of the invention, an information recording medium transport section is formed by the medium separating roller 21 of the information recording medium feeding mechanism, the erasing heater 25 and the platen roller 26 of the image erasing unit, and the printing head 32 and the platen roller 33 of the image forming unit. Another pair of rollers constituted by a drove roller and an opposite roller may be provided at the medium transport path 23.

Further, the image forming apparatus 1 in Embodiment 1 of the invention is provided with an interface for connections (including network connection) with externally connected apparatus such as a PC (personal computer) and a POS terminal.

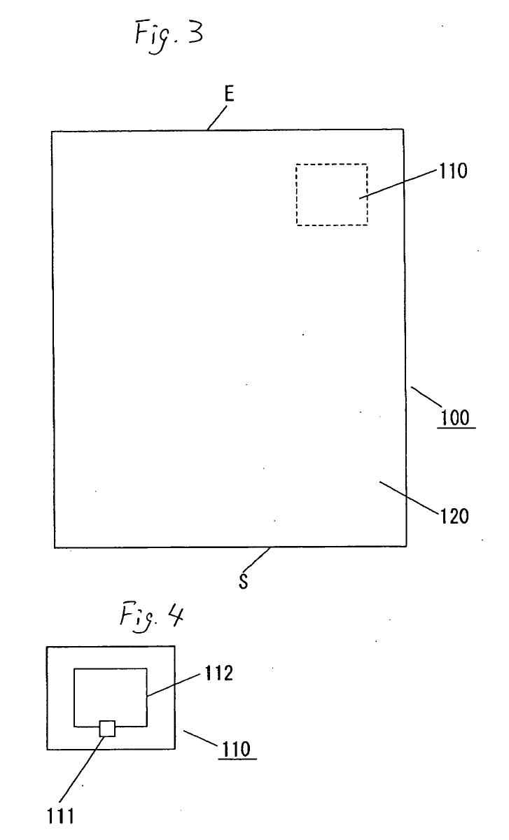

The information recording medium will now be described. FIG. 3 is a plan view of an information recording medium according to Embodiment 1 of the invention. FIG. 4 is a perspective plan view of a radio communication medium according to Embodiment 1 of the invention.

In FIG. 3, reference numeral 100 represents an information recording medium (hereinafter also referred to as a medium briefly); reference numeral 110 represents an RF ID tag as a radio communication medium; and reference numeral 120 represents a display section. S represents the leading end of the medium 100, and E represents a rear end of the same.

As shown in FIG. 3, the RF ID tag 110 as a radio communication medium is attached to the medium 100. In FIG. 3, the RF ID tag 110 is attached to the back side of the medium 100, and it is indicated by the broken line. The display section 120 is provided on the top side of the medium 100. The display section 120 of the medium 100 is constituted by a rewrite layer which is made of heat reversible material and formed on the base material of the medium 100.

Various materials may be used as the base material of the medium 100, including plastics such as polyethylene terephthalate (PET), polyvinyl chloride (PVC), polyvinyl chloride acetate (PVCA), polycarbonate (PC), and biodegradable materials, paper and synthetic paper. Plastics such as PET and synthetic paper are preferred from the viewpoint of heat resistance and flexibility.

An example of a heat reversible material used for the display section 120 is a reversible heat-recording material which is obtained by dispersing an organic monomeric substance such as a higher fatty acid in a polymeric matrix that is a resin matrix and which reversibly changes between a transparent state and a cloudy state. Another example is a reversible heat-coloring composition obtained using a combination of a coloring agent and a developer. Such a material or composition properly selected is directly applied to the base material of the medium 100 to form a film thereon. Alternatively, the material or composition may be used by applying it to a sheet or label which is then applied to the base material of the medium 100.

The display section 120 utilizing such a heat reversible material is colored at temperatures beyond a predetermined value and is decolorized when a predetermined temperature range is maintained for a certain time. As described above, an image in the display section 120 of the medium 100 is erased by the erasing heater 25, and an image is formed in the display section 120 of the medium 100 by the printing head 32.

In FIG. 4, reference numeral 111 represents an IC chip, and reference numeral 112 represents an antenna coil. As shown in FIG. 4, the RF ID tag 110 has a configuration in which the IC chip 111 and the antenna coil 112 are provided on or in the base material thereof.

While a configuration of the image forming apparatus 1 and the information recording medium 100 have been described above, a description will now be made on the erasure or formation of an image in the a recording medium 100 in the image forming apparatus 1 and a procedure for communication between an information recording medium 100 and an RF ID tag 110.

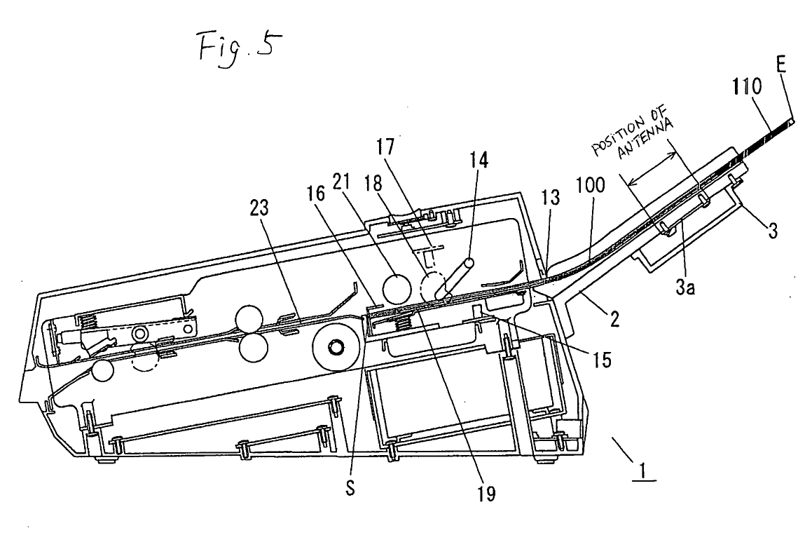

FIGS. 5 to 8 are side sectional views of the image forming apparatus in Embodiment 1 of the invention.

First, as shown in FIG. 5, a medium 100 is set in the image forming apparatus 1. Let us now assume that a plurality of sheets of the medium 100 is set. The medium detection member 14 rotates by being urged by the medium 100 inserted from the insertion opening 13. The sensor 15 detects the rotation, it can consequently check whether there is a medium 100 or not. Information on the detection of the medium 100 is transmitted to externally connected apparatus connected through the interface which is not shown, and it is recognized by the apparatus that the setting of the medium 100 has been completed. Since the cam 18 keeps urging the medium-urging metal fitting 19 downward, the medium 100 can be inserted, and the leading end S of the same abuts on the engaging section 16 to position the medium. When the medium 100 is thus set, the loop antenna 3a of the antenna section 3 and the RF IF tag 110 of the medium 100 are not aligned with each other in the tray 2.

When the setting of the medium 100 is completed, the image forming apparatus 1 is enabled for processing by an instruction from an externally connected apparatus. First, the cam 18 rotates until it is detected by the sensor 17. When the cam 18n rotates to the position where it is detected, the medium-urging metal fitting 19 moves upward to put the medium 100 in contact with the medium separating roller 21. Friction between the medium separating roller 21 and the medium 100 or the transport force of the rotating medium separating roller 23 disengages the medium 100 from the engaging section 16 at both edges of the leading end S in the width direction thereof, and the medium 100 is transported into the medium transport path 23. At this time, only one sheet of the medium 100 that is located on top of the plurality of sheets of the medium 100 thus set is transported into the medium transport path 23.

As shown in FIG. 6, when the medium 100 is transported to the position where the leading end S thereof is detected by the sensor 24, the loop antenna 3a of the antenna section 3 and the RF ID tag 110 of the medium 100 are aligned with each other in the tray 2. Then, the antenna section 3 communicates with the RF ID tag 110 provided at the medium 100 to enable processes on the RF ID tag 110.

Since the loop antenna 3a is aligned with a particular (one) RF ID tag 110 when the RF ID tag 110 is to be processed as thus described, a plurality of RF ID tags 110 can be sequentially processed.

An example of a process on an RF ID tag 110 will now be described.

When only power is supplied from the radio communication medium processing unit constituted by the antenna section 3 and the RF ID tag control substrate 12 as a reader/writer unit connected to the same to the RF ID tag 110 (standby mode), in the RF ID tag control substrate 12, a high frequency signal having a predetermined amplitude is supplied from an oscillation circuit to the radio transmission section. The signal is then amplified and transmitted to the loop antenna 3a of the antenna section 3 through a feeder line. At the RF ID tag 110, the high frequency signal is supplied to the IC chip 111 through the antenna coil 112 which is electromagnetically coupled to the loop antenna 3a. The high frequency signal is rectified by a rectifier circuit in the IC chip 111 to generate a predetermined power supply voltage required for each part of the RF ID tag 110.

A description will now be made on a case in which data is transmitted from the radio communication medium processing unit to the RF ID tag 110 (transmission mode). Data from an externally connected apparatus are transmitted to the radio transmission section through the control section of the RF ID tag control substrate 12. A high frequency signal having a predetermined amplitude similar to that in the standby mode is supplied to the radio transmission section, and the high frequency signal is modulated by the data to output a modulated high frequency signal. The modulated high frequency signal is transmitted to the loop antenna 3a through a feeder line. At the RF ID tag 110, the high frequency signal is supplied to the IC chip 111 through the antenna coil 112 which is electromagnetically coupled to the loop antenna 3a. The high frequency signal is rectified by the rectifier circuit similarly to that in the standby mode to generate a predetermined power supply voltage required for each part of the RF ID tag 110. The signal output by the antenna coil 112 is also supplied to a reception circuit in the IC chip 111. The data are demodulated in this part and written in a memory.

A description will now be made on a case in which the radio communication medium processing unit receives data from the RF ID tag 110 (reception mode). An unmodulated high frequency signal having a predetermined amplitude similar to that in the standby mode is output from the radio transmission section of the RF ID tag control substrate 12 and is transmitted to the RF ID tag 110 through the loop antenna 3a and the antenna coil 112, thereby generating a predetermined power supply voltage required for each part of the RF ID tag 110 just as in the standby mode. At the RF ID tag 110, for example, a load resistance and a switch are provided in connection with the antenna coil 112, and the switch is turned on and off according to “1” and “0” bits of data read from the memory. When the switch is turned on and off as described above, at the radio communication medium processing unit, load fluctuations occur on the antenna coil 112 to cause fluctuations of the impedance of the loop antenna 3a through electromagnetic induction. The amplitude of the high frequency signal consequently fluctuates. That is, the amplitude of the high frequency signal is modulated by the data from the RF ID tag 110. Data are acquired by demodulating the modulated high frequency signal at the radio reception section of the RF ID tag control substrate 12. The data are processed by the control section and transmitted to the externally connected apparatus.

When the medium 100 is transported to the position where the leading end S thereof is detected by the sensor 24, depending on the volume of data to be read from or recorded in the RF ID tag 110, the medium 100 may be stopped in that position to enable the process on the RF ID tag 110 of the medium 100, for example, when the data volume is large. Alternatively, the process on the RF ID tag 110 of the medium 100 may be enabled while transporting the medium 100 when the data volume is small. The speed of transportation of the medium 100 may be determined in accordance with the time for processing the RF ID tag 110 that depends on the volume to be read out or recorded to improve the processing speed.

When the process on the RF ID tag 110 is completed, the medium 100 is further transported in the medium transport path 23 to be sandwiched between the erasing heater 25 as an image erasing unit and the platen roller 26. Then, the image recorded in the display section 120 of the medium 100 is erased by heat from the erasing heater 25.

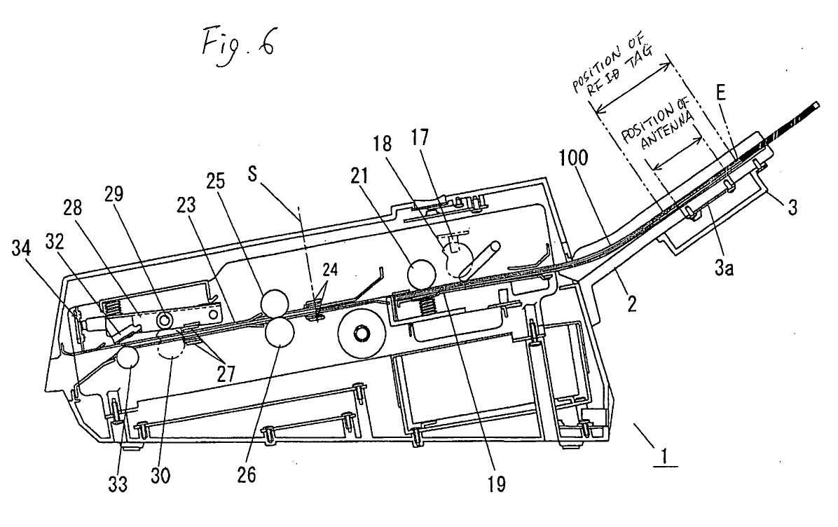

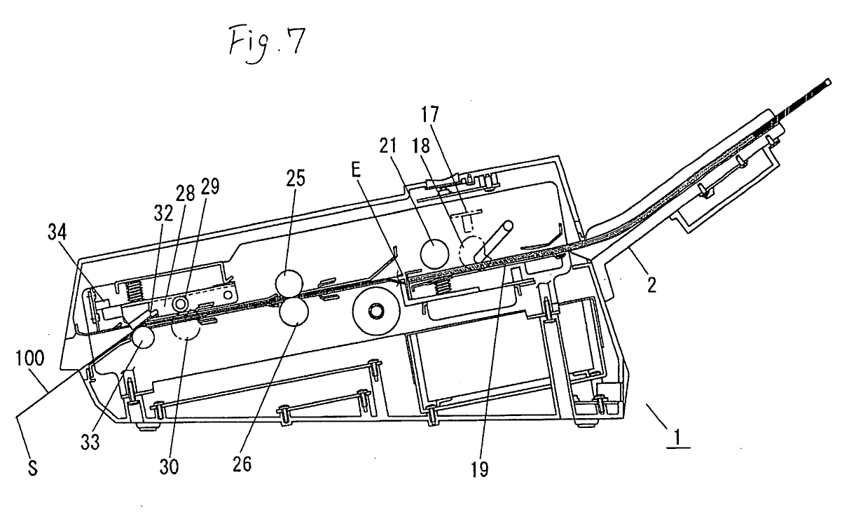

When the medium 100 is further transported and moved a predetermined amount after the sensor 27 detects the leading end S of the medium 100 (the amount being calculated from the elapse time or the amount fed by the transport section after the detection by the sensor 27), the cam 30 rotates to move the printing unit 28 downward and to protrude the printing unit 28 into the medium transport path 23. The sensor 34 detects the state of elevation caused by the upward and downward movements of the printing unit 28. The medium 100 is sandwiched between the printing head 32 of the printing unit 28 as an image forming/erasing unit and the platen roller 33, and an image is formed in the display section 120 of the medium 100 by the printing head 32. The states of the image erasure and image formation at the display section 120 of the medium 100 are as shown in FIG. 7.

When the medium 100 is sandwiched between the erasing heater 25 and the platen roller 26 at the leading end S thereof and is no longer in a need for the transport force of the medium separating roller 21 and at least before the rear end E of the first medium 100 passes through the medium separating roller 21, the cam 18 rotates to move the medium-urging metal fitting 19 downward. Since any contact between the second medium 100 and the medium separating roller 21 is thus prevented at this timing, there is no possibility of feeding overlapping sheets of the medium. The timing of the rotation of the cam 18 is calculated from the elapse time or the amount fed by the transport unit after the detection of the leading end S of the medium 100 by the sensor 24 or sensor 27 or the dimension of the medium 100 in the longitudinal direction thereof (transporting direction).

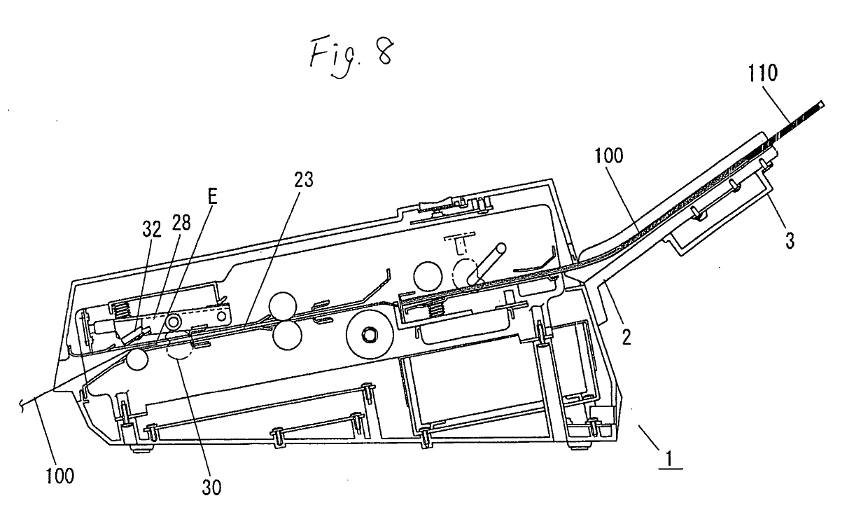

As shown in FIG. 8, the medium 100 is discharged from the discharge opening 6 when the image formation is completed. When the image formation is completed, the cam 30 rotates to move the printing unit 28 upward to retract the printing unit 28 from the medium transport path 23. The image forming apparatus 1 then enters a standby state in which it waits for an instruction for processing on the second sheet from the externally connected apparatus.

While a configuration of the image forming apparatus 1 and a procedure for processing the medium 100 have been described above, a description will now be made on examples of images formed in a display section 120 of a medium 100 according to Embodiment 1 of the invention.

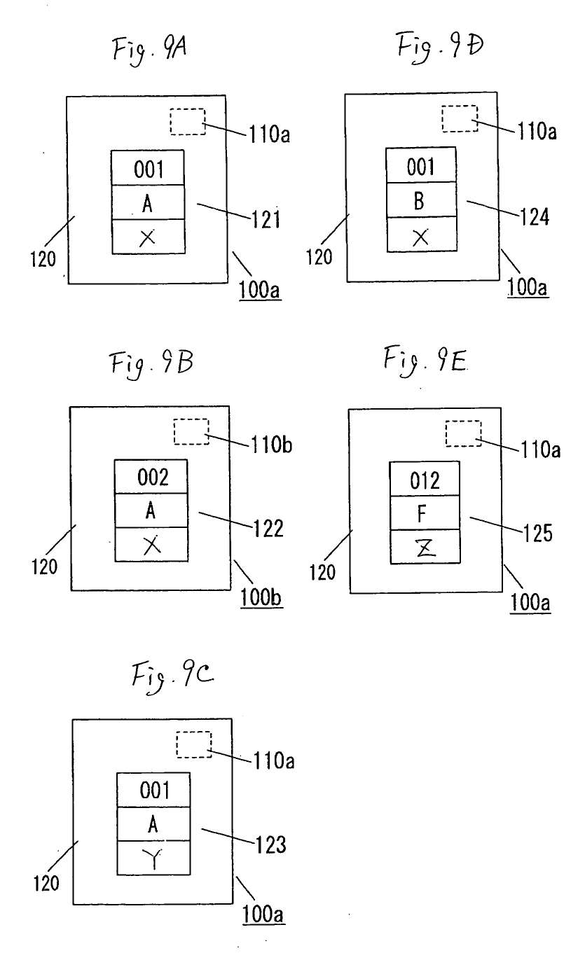

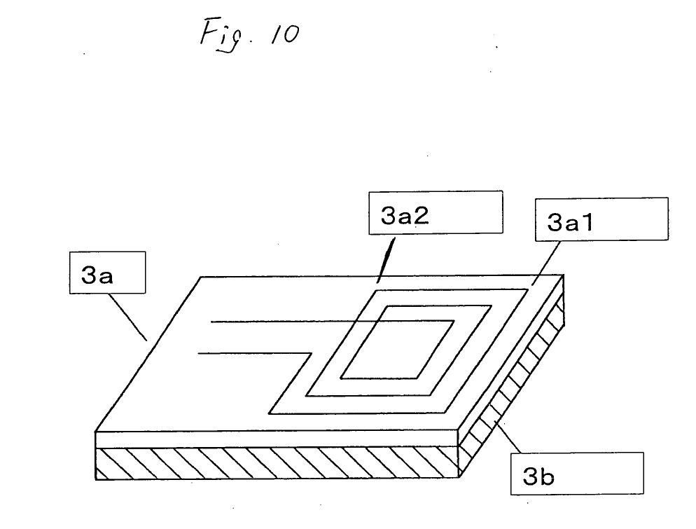

FIGS. 9A to FIG. 9E are plan views of examples of information recording media according to Embodiment 1 of the invention. As shown in FIG. 9A, an image 121 is formed in a display section 120 of a display section 120 of a medium 100a. At this time, the information in the image 121 and the information recorded in an RF ID tag 110a at least include pieces of information identical to each other. There is a variety of pieces of information which depend on the RF ID system in which the medium 100a is used. By way of example, when the RF ID system is used in a physical distribution system, the medium 100a may be a delivery slip or management slip, and the information in the image 121 and the information recorded in the RF ID tag 110a may include the names of the consignee and the shipper, the type of the commodity, the type and weight of the package, and the date of shipment.

As shown in FIG. 9B, an image 122 is formed in a display section 120 of a medium 10b. The relationship between the medium 100a and the medium 100b shown in FIGS. 9A and 9B is an example of a relationship between first and second sheets of a medium processed by the image forming apparatus 1.

The image 121 in the display section 120 of the medium 100a shown in FIG. 9A may be erased to form a new image 123 or 124 as shown in FIG. 9C or 9D in the section. The images 123 and 124 in FIGS. 9C and 9D show cases in which partial changes are made to the image 121. In such cases, the information recorded in the RF ID tags 110a of the respective medium 100a is also changed.

Further, the image 121 in the display section 120 of the medium 100a shown in FIG. 9A is erased, and a new image 125 shown in FIG. 9E is formed. The image 125 shows an example of a case in which changes are made to all items associated with the image 121. Obviously, the information recorded in the RF ID tag 110a is changed at the same time, and the information in the image 125 and the information recorded in the RF ID tag 110a at least include pieces of information that are identical to each other.

While an embodiment of the invention has been described above, the invention is not limited to the same and may be modified in various ways. The image forming apparatus of the present embodiment may be used in various RF ID systems.

The invention provides an image forming apparatus for forming an image in an information recording medium including a radio communication medium such as an RF ID tag and erasing an image in the same, the apparatus being applicable to usage in which an image forming apparatus must have a large processing capacity and a small size.

This application is based upon and claims the benefit of priority of Japanese Patent Application No. 2004-51101 filed on Feb. 26, 2004, the contents of which are incorporated herein by reference in its entirety.

1. An image forming apparatus comprising:
an image recording medium supplying unit in which an information recording medium including a radio communication medium is provided;
a transport path in which the information recording medium supplied from the information recording medium supplying unit is transported;
a transport unit for transporting the recording medium;
an image erasing unit for erasing an image formed in the information recording medium;
an image forming unit for forming an image in the information recording medium; and
at least an antenna section of a radio communication medium processing unit communicating with the radio communication medium of the information recording medium, the antenna section being provided in the information recording medium supplying unit.

2. An image forming apparatus according to claim 1, wherein the information recording medium supplying unit has a tray and an information recording medium feeding mechanism for feeding the information recording medium into the transport path.

3. An image forming apparatus according to claim 2, wherein the antenna section is provided at the tray.

4. An image forming apparatus according to claim 3, wherein the antenna section and the radio communication medium of the information recording medium are not positioned to confront with each other when the information recording medium is placed on the tray.

5. An image forming apparatus according to claim 2, wherein the information recording medium feeding mechanism, the transport path, the transport unit, the image erasing unit, and the image forming unit are provided in a housing.

6. An image forming apparatus according to claim 5, wherein the information recording medium feeding mechanism, the transport path, the transport unit, the image erasing unit, and the image forming unit are provided in a chassis.

7. An image forming apparatus according to claim 6, wherein the radio communication medium processing unit has a reader/writer unit connected to the antenna section and in that the reader/writer unit is provided in a location different from the chassis in the housing.

8. An image forming apparatus according to claim 2, wherein the transport unit comprises at least the information recording medium feeding mechanism, the image erasing unit, and the image forming unit.

9. An image forming apparatus according to claim 1, wherein the image erasing unit always protrudes into the transport path.

10. An image forming apparatus according to claim 1, wherein the image forming unit enters to and exit from the transport path.
